(19) United States
(12) Patent Application Publication
(10) Pub. No.: US 2008/0223447 A1
(43) Pub. Date: Sep. 18, 2008

(54) Serviceable double block and bleed valve

(76) Inventor: Steve Froehler, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 12/068,872

(22) Filed: Feb. 13, 2008

Related U.S. Application Data
(60) Provisional application No. 60/901,317, filed on Feb. 15, 2007.

(51) Int. Cl. F16K 11/20; F16K 43/00

(52) U.S. Cl. 137/15.18; 137/597; 137/613

(57) ABSTRACT

A serviceable double block and bleed valve is provided, having a futbol, and having an integral body having two block valves and one bleed valve and a flange on its inlet end which is bolted to a mating flange of the futbol The double block and bleed valve is installed on the process pipe by welding of the inlet of the futbol to the process pipe, while servicing or replacement of the integral body or any parts associated therewith is achieved through removal of the bolts holding the mating flanges together.

### FIELD OF THE INVENTION

The invention relates to double block and bleed valves and more particularly to systems of attachment of double block and bleed valves to a process pipeline.

### BACKGROUND OF THE INVENTION

In industrial applications involving processes contained in a pipeline system, it is typically required that monitoring instrumentation be employed to ensure that the conditions within the pipe are ideal for the process, and to otherwise monitor the process to ensure operations within the pipe system are occurring within normal expected parameters. This is typically measured by tapping into the pipeline and exposing instrumentation to the process.

In industrial applications in which the process in the pipeline has elevated temperatures and/or pressures, is toxic, or is otherwise hazardous in nature, care must be taken to ensure personnel who operate and/or service the monitoring instrumentation are protected from the dangerous nature of the process. Typically this is achieved through use of a failsafe in the form of a double block and bleed valve (DB&B) 100 as illustrated in FIG. 1A, in which a first block valve 110 is situated relatively proximate an inlet 115 which is in fluid communication with the process in the pipe 50, a second block valve 120 is situated proximate an outlet 125 which is coupled to the instrumentation (not shown), and a bleed or vent valve 130 is situated to bleed or vent an inner channel 140 coupling the first and second block valves 110, 120. The first block valve 110 serves as the primary safety mechanism. If the first block valve 110 is compromised due to excessive pressures and/or other conditions which have compromised its capability to contain the process, the bleed or vent valve 130 serves to let off the excess pressure or other condition through a vent port 135 to reduce the strain on the second block valve 120 allowing it to contain the remaining process ensuring the instrumentation operator's safety.

One of the areas DB&B valves are used in is the gas and oil industry specifically in the isolation of steam used for heating bitumen in heavy oil production. Steam used in this process typically has pressures exceeding 1000 PSI and 500° F. Other applications relying on steam which utilize DB&B valves include geothermal power generation and power utilities that produce steam to drive turbines. Often in oil refineries, hydrogen sulfide and carbon dioxide, which in the presence of water become sulfuric and carbonic acid respectfully, are processed in what are known as acid gas units. In addition to being acidic, the compounds in these acid gas units are both toxic and flammable. This is the sort of environment ideal for use of DB&B valves.

There are two known types of installations of DB&B valves on process pipes.

A first known type is an installation is depicted in FIG. 1A, in which the DB&B valve 100 is mounted via a weldolet 80 welded to the outside of the pipe 50, having a hole drilled through its center in which the DB&B valve 100 is mounted and welded. The process pipe 50 has a matching aperture 55 allowing fluid communication from the inside of the pipe 50 to the DB&B valve 100. In this installation the DB&B 100 valve is not removable. Valves are typically matched to the process pipe to ensure it lasts as long as the process pipe. In some cases however the valve and the pipe may be metallurgically mismatched, or as in some cases, a level of corrosion acceptable for reliability of the pipe may exceed the performance and operating parameters of the valve's moving parts. In such cases the valve will need to be replaced or serviced before the pipe. In this type of installation the DB&B valve 100 needs to be cut out of the weldolet 80 for servicing or replacement. Although the simplicity of the installation translates into a time and cost savings at installation, the subsequent cutting out of a DB&B valve 100 every time it needs to be serviced or replaced is a costly and time consuming exercise.

A second known type of installation is depicted in FIG. 1B, in which the a Tee 60 is welded into the process pipe 50. The Tee 60 is connected to a flanged DB&B valve 200 by a Tee flange 70 welded to the end of the Tee branch of the Tee 60. The flanged DB&B valve 200 has a mating flange 290 at the inlet 115 end of the DB&B valve 200 for connection to the Tee flange 70. This type of flanged installation has the advantage of providing easy removal of the DB&B valve 200 when it needs to be serviced or replaced. One major disadvantage of this type of installation is the extra materials and labor costs involved in installing the flanged Tees 70 at every location along the process pipe 50 where a DB&B valve 200 is to be installed. In addition to material and labor, every installation must undergo very expensive non-destructive testing such as x-ray testing or mag particle examination. Although this type of installation provides ease of replacement of a DB&B valve 200 for servicing and removal, it presents substantial intitial installation costs.

### SUMMARY OF THE INVENTION

According to a first aspect the invention provides for a double block and bleed valve for installation on a process pipe, the double block and bleed valve comprising: an inlet for providing fluid communication of the valve to the process pipe; an inlet flange defined about the inlet; and a futbol having a futbol flange at one end for mating with said inlet flange, and having a futbol inlet for mounting to the process pipe.

According to another aspect the invention provides for a double block and bleed valve for installation on a process pipe, the double block and bleed valve comprising: an integral body comprising an inlet, an outlet, a vent, an inner channel in fluid communication with the inlet, the outlet, and the vent; a first block valve between the inlet and the inner channel; a second block valve between the outlet and the inner channel; a bleed valve between the inner channel and the vent; an inlet flange defined about the inlet; and a futbol having a futbol flange at one end for mating with said inlet flange, and a futbol inlet at an other end for mounting to the process pipe.

According to a further aspect the invention provides for a double block and bleed valve kit for installation on a process pipe, the double block and bleed valve kit comprising: an integral body having an inlet for providing fluid communication of the valve to the process pipe, an inlet flange defined about the inlet; and a futbol having a futbol flange at one end for mating with said inlet flange, and having a futbol inlet for mounting to the process pipe.

Some embodiments of the invention further provide for a plurality of flange bolts for securing the inlet flange to the futbol flange.

According to yet another aspect, the invention provides for a method of installing the double block and bleed valve comprising: securely bolting the inlet flange to the futbol flange; and welding the futbol inlet to the process pipe.

According to another further aspect the invention provides for a method of installing the double block and bleed kit comprising: securing the integral body to the futbol by bolting the inlet flange to the futbol flange with a plurality of flange bolts; and mounting the futbol inlet of the futbol to the process pipe.

According to another aspect the invention provides for a method of disassembly of an installed double block and bleed valve, the method comprising: unbolting the inlet flange from the futbol flange; and unmating the inlet flange from the futbol flange.

According to another aspect the invention provides for a method of disassembly of an installed double block and bleed kit, the method comprising: separating the integral body from the futbol by unbolting the inlet flange from the futbol flange; and unmating the inlet flange from the futbol flange.

### BRIEF DESCRIPTION OF THE DRAWINGS

The features and advantages of the invention will become more apparent from the following detailed description of the preferred embodiments with reference to the attached figure, wherein:

FIG. 1A is a schematic block diagram illustrating a known installation of a double block and bleed valve on a process pipe;

FIG. 1B is a schematic block diagram illustrating a known installation of a double block and bleed valve on a Tee of a process pipe;

FIG. 2A is an elevation view of a double block and bleed valve according to the preferred embodiment of the invention;

FIG. 2B is a side view of the double block and bleed valve according to the preferred embodiment of the invention;

FIG. 2C is a plan view of the double block and bleed valve according to the preferred embodiment of the invention; and

FIG. 3 is a schematic block diagram illustrating installation of the double block and bleed valve according to the preferred embodiment of the invention to a process pipe.

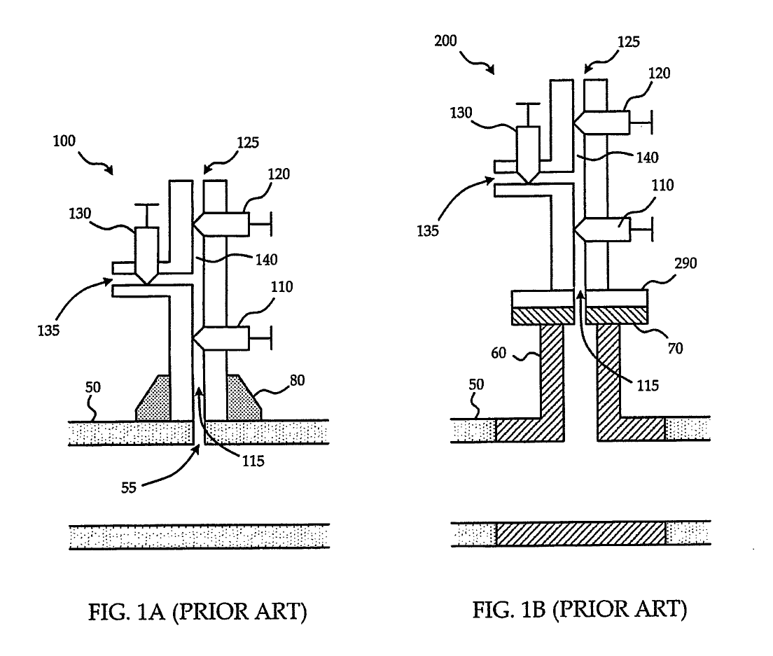

### DETAILED DESCRIPTION OF THE PREFERRED EMBODIMENTS

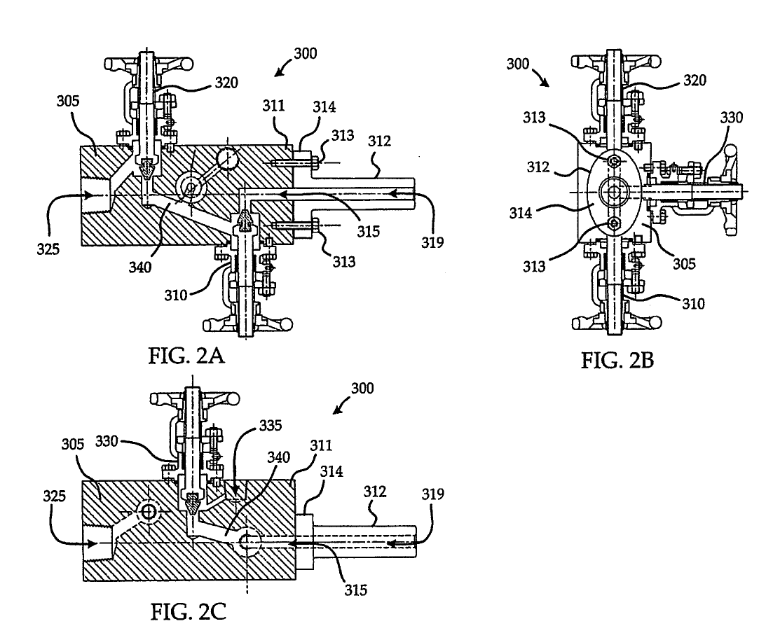

Referring to FIGS. 2A, 2B, and 2C a double block and bleed valve 300 according to the preferred embodiment of the invention will now be discussed. In the DB&B valve 300 of the preferred embodiment an integral body 305 makes up most of the valve 300. The integral body 305 has a first block valve 310 situated relatively proximate an inlet 315 which is in fluid communication with the process in the pipe (not shown), and a second block valve 320 situated proximate an outlet 325 which is coupled to the instrumentation (not shown), and a bleed or vent valve 330 situated to bleed or vent an inner channel 340 coupling the first and second block valves 310, 320. The first block valve 310 serves as the primary safety mechanism. If the first block valve 310 is compromised due to excessive pressures and/or other conditions which have compromised its capability to contain the process, the bleed or vent valve 330 serves to let off the excess pressure or other condition through a vent port 335 to reduce the strain on the second block valve 320 allowing it to contain the remaining process ensuring the instrumentation operator's safety. At the inlet end of the DB&B valve 300 is a futbol 312 which has a futbol flange 314 for mating with an inlet flange 311 formed on the inlet end of the integral body 305 The futbol 312 and the integral body 305 are secured by the mating flanges 311, 314 being secured with two flange bolts 313. In the preferred embodiment, the mating flanges ensure a fluid seal once the flange bolts 313 are sufficiently tightened. The inlet 319 of the futbol 312 provides for fluid communication between the process in the process pipe 350 and the inlet 315 of the integral body 305 of the DB&B valve 300. The futbol 312 may be a commonly available futbol having appropriate operational tolerances for the nature of the process, or one which is of a custom construction. In the preferred embodiment, the futbol 312 is a widely available industry standard 2-bolt futbol having appropriate tolerances. Use of this type of futbol 312 avoids the production costs associated with manufacturing a futbol of custom design The DB&B valve of the preferred embodiment 300 is advantageously designed to provide for simple and cost effective installation on a process pipe, while at the same time providing for simple and cost effective disassembly when subsequent servicing or replacement is needed.

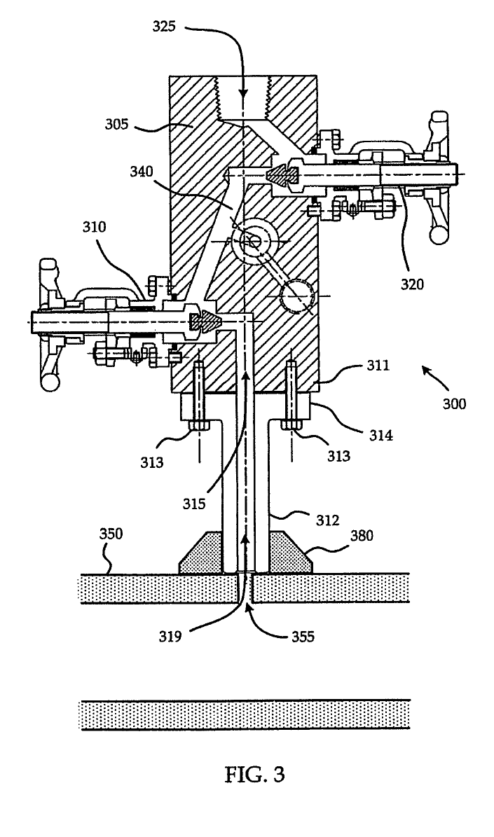

Referring not to FIG. 3, an installation and servicing of the double block and bleed valve 300 according to the preferred embodiment of the invention to a process pipe 350 will now be described.

Installation of the DB&B valve 300 on the process pipe 350 involves welding of a weldolet 380 to the outside of the pipe 350, having a hole drilled through its center in which the inlet end of the futbol 312 of the 3DB&B valve 300 is mounted and welded. The process pipe 350 has a matching aperture 355 allowing fluid communication from the inside of the pipe 350 to the DB&B valve 300. As described above the integral body 305 of the DB&B valve 300 of the preferred embodiment is secured to the futbol by mating of its inlet flange 311 to the futbol flange 314 and the use of two flange bolts 313. Installation of the DB&B valve 300 according to the preferred embodiment of the invention is both simple and cost effective, requiring little time, material, and labor.

In this installation the futbol 312 of the DB&B valve 300 is not easily removable from the process pipe 350. The futbol 312, however, will not require servicing or replacement as often as the integral body 305 and its associated parts of the DB&B valve 300 will require throughout the lifetime of the installation. When the integral body 305 or any of its associated parts requires servicing or replacement, flange bolts 313 may be loosened and the integral body 305 may be separated from the futbol 312 which remains welded to the weldolet 380 and the process pipe 350. Freeing of the integral body 305 of the DB&B valve 300 is a simple task, minimizing time and labor costs. Once freed, the integral body 305 and any of its associated parts may be serviced or replaced relatively easily. A serviced or replacement integral body of a DB&B valve can be reinstalled simply by mating of its inlet flange 311 to the futbol flange 314 and securing it by tightening the flange bolts 313 appropriately.

Although the preferred embodiment has been described such that the mating flanges accept two flange bolts, any person skilled in the art would understand that any number of bolts of sufficient strength and appropriate placement may be used to secure the inlet flange 311 to the fultbol flange 314.

Although the preferred embodiment has been described as being installed on a process pipe 350 by way of mounting and welding to a weldolet 380, any other appropriate and permanent fixing of the futbol 312 of the DB&B valve 300 to the process pipe 350 at a matching aperture 355 is contemplated by the invention.

The embodiments presented are exemplary only and persons skilled in the art would appreciate that variations to the embodiments described above may be made without departing from the spirit of the invention. The scope of the invention is solely defined by the appended claims.

We claim:

1. A double block and bleed valve for installation on a process pipe, the double block and bleed valve comprising:
an inlet for providing fluid communication of the valve to the process pipe;
an inlet flange defined about the inlet; and
a futbol having a futbol flange at one end for mating with said inlet flange, and having a futbol inlet for mounting to the process pipe.

2 A double block and bleed valve for installation on a process pipe, the double block and bleed valve comprising:
an integral body comprising an inlet, an outlet, a vent, an inner channel in fluid communication with the inlet, the outlet, and the vent;
a first block valve between the inlet and the inner channel;
a second block valve between the outlet and the inner channel;
a bleed valve between the inner channel and the vent;
an inlet flange defined about the inlet; and
a futbol having a futbol flange at one end for mating with said inlet flange, and a futbol inlet at an other end for mounting to the process pipe.

3. A double block and bleed valve kit for installation on a process pipe, the double block and bleed valve kit comprising:
an integral body having an inlet for providing fluid communication of the valve to the process pipe, an inlet flange defined about the inlet; and
a futbol having a futbol flange at one end for mating with said inlet flange, and having a futbol inlet for mounting to the process pipe.

4. A double block and bleed valve kit according to claim 3 further comprising a plurality of flange bolts for securing the inlet flange to the futbol flange.

5. A method of installing the double block and bleed valve as defined in claim 1 on a process pipe, the method comprising:
securely bolting the inlet flange to the futbol flange; and
welding the futbol inlet to the process pipe.

6. A method of installing the double block and bleed kit as defined in claim 3, the method comprising:
securing the integral body to the futbol by bolting the inlet flange to the futbol flange with a plurality of flange bolts; and
mounting the futbol inlet of the futbol to the process pipe.

8. A method of disassembly of an installed double block and bleed valve as defined in claim 1, the method comprising:
unbolting the inlet flange from the futbol flange; and
unmating the inlet flange from the futbol flange.

9. A method of disassembly of an installed double block and bleed kit as defined in claim 3, the method comprising:
separating the integral body from the futbol by unbolting the inlet flange from the futbol flange; and
unmating the inlet flange from the futbol flange.
